(19) United States
(12) Patent Application Publication
(10) Pub. No.: US 2014/0063206 A1
(43) Pub. Date: Mar. 6, 2014

(54) SYSTEM AND METHOD OF VIEWER CENTRIC DEPTH ADJUSTMENT

(71) Applicants: NATIONAL TAIWAN UNIVERSITY, Taipei (TW); HIMAX TECHNOLOGIES LIMITED, Tainan City (TW)

(72) Inventors: Liang-Gee Chen, Taipei (TW); Chien Wu, Taipei (TW); Chung-Te Li, Taipei (TW); Chen-Han Chung, Taipei (TW); Cheng-Yuan Ko, Taipei (TW); Ling-Hsiu Huang, Tainan City (TW)

(73) Assignees: HIMAX TECHNOLOGIES LIMITED, Tainan City (TW); NATIONAL TAIWAN UNIVERSITY, Taipei (TW)

(21) Appl. No.: 13/760,467

(22) Filed: Feb. 6, 2013

Related U.S. Application Data
(60) Provisional application No. 61/694,006, filed on Aug. 28, 2012.

(51) Int. Cl. H04N 13/00; H04N 13/04

(52) U.S. Cl. CPC H04N 13/0022; H04N 13/0468; H04N 13/0033
USPC 348/51

(57) ABSTRACT

In a system and method of viewer centric depth adjustment, a sensor measures viewing distance of a viewer from a screen; and a depth remapping unit receives a color image, a depth map and the viewing distance, and accordingly remaps depth values of the depth map such that the viewer perceives same depth at different viewing distances.

### CROSS-REFERENCE TO RELATED APPLICATIONS

This application claims the benefit of U.S. Provisional Application No. 61/694,006 (Att. Docket NU8707PR), filed on Aug. 28, 2012 and entitled “Viewer Centric Depth Adjustment For Stereoscopic Images,” the entire contents of which are incorporated herein by reference.

### BACKGROUND OF THE INVENTION

1. Field of the Invention

The present invention generally relates to stereoscopic images, and more particularly to a system and method of viewer centric depth adjustment for stereoscopic images.

2. Description of Related Art

With the development of 3DTV technology, more and more applications of 3D retargeting are expected to spring up in the next generation of 3D display. The main purpose is applying adjustment technology to provide comfortable viewing experience. It is, however, claimed by many people that after watching 3D videos for a long period of time, they suffer from headache and eye fatigue caused by 3D contents. Hence many researchers worked on depth adjustment to improve these artifacts.

Relative size is the measure of the projected retinal size of objects or textures that is physically similar in size at different viewing distance. Moreover the relative size cue is effective from 0.5m to 5000m. If the object size is H, the retinal image size is R, and the focal length of human eyes is F, the viewing distance D can be given as D=F×H/R.

FIG. 1A to FIG. 1E show some examples of viewing geometry. As viewer moves backward from the screen, the left and right views remain the same. In FIG. 1B, it is shown that viewer may have the experience of increasing in depth perception. However, if the viewer moves forward to the screen, the ratio of baseline over screen size decreased; therefore, in FIG. 1C viewer may feel a decreased depth perception. In FIG. 1D, it is shown that when decreasing the disparity of an object, viewer may feel magnification of the object. In FIG. 1E, object becomes smaller than the original one.

In order to further improve 3D viewing experience, a need has arisen to propose a novel scheme of viewer centric depth adjustment for stereoscopic images.

### SUMMARY OF THE INVENTION

In view of the foregoing, it is an object of the embodiment of the present invention to provide a system and method of viewer centric depth adjustment for stereoscopic images to adjust both object size and disparity map, therefore providing better viewing experience by minimizing the distortion mentioned above.

According to one embodiment, a system of viewer centric depth adjustment includes a sensor and a depth remapping unit. The sensor is configured to measure viewing distance of a viewer from a screen. The depth remapping unit is configured to receive a color image, a depth map and the viewing distance, and accordingly to remap depth values of the depth map such that the viewer perceives same depth at different viewing distances.

### BRIEF DESCRIPTION OF THE DRAWINGS

FIG. 1A to FIG. 1E show some examples of viewing geometry;

FIG. 2 shows a block diagram illustrative of a system of viewer centric depth adjustment for stereoscopic images according to one embodiment of the present invention; and

FIG. 3 shows a detailed block diagram of the depth remapping unit of FIG. 2.

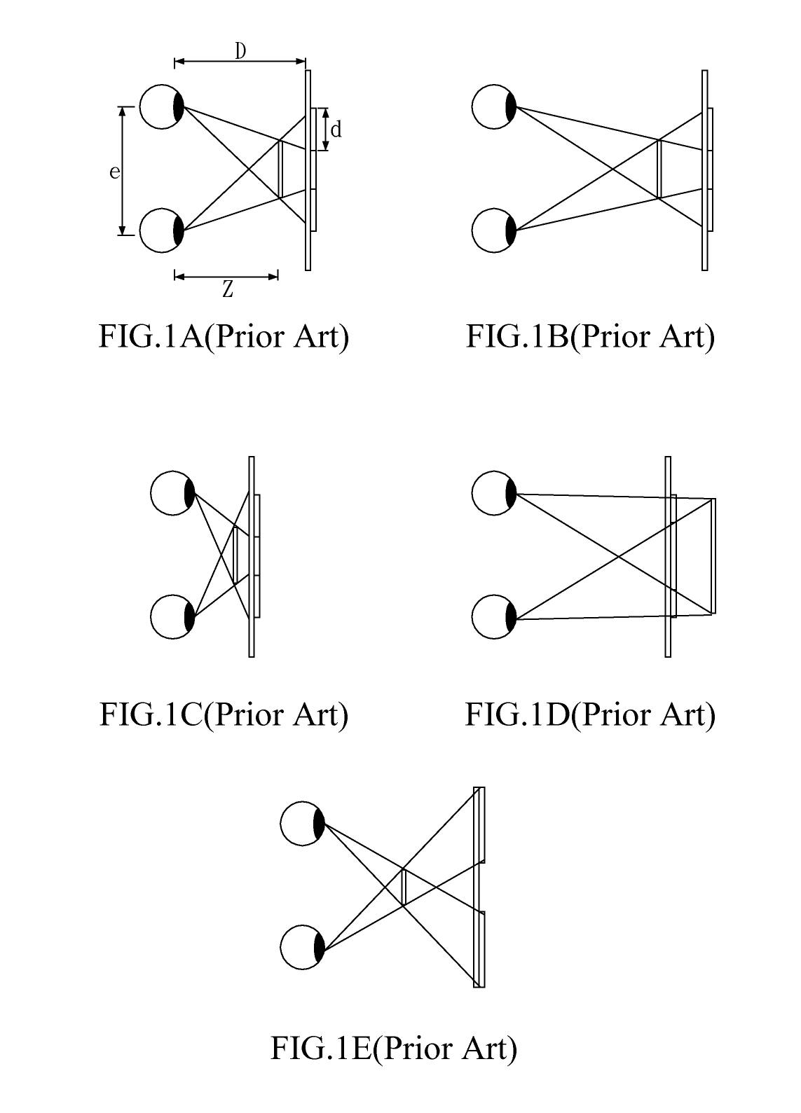

### DETAILED DESCRIPTION OF THE INVENTION

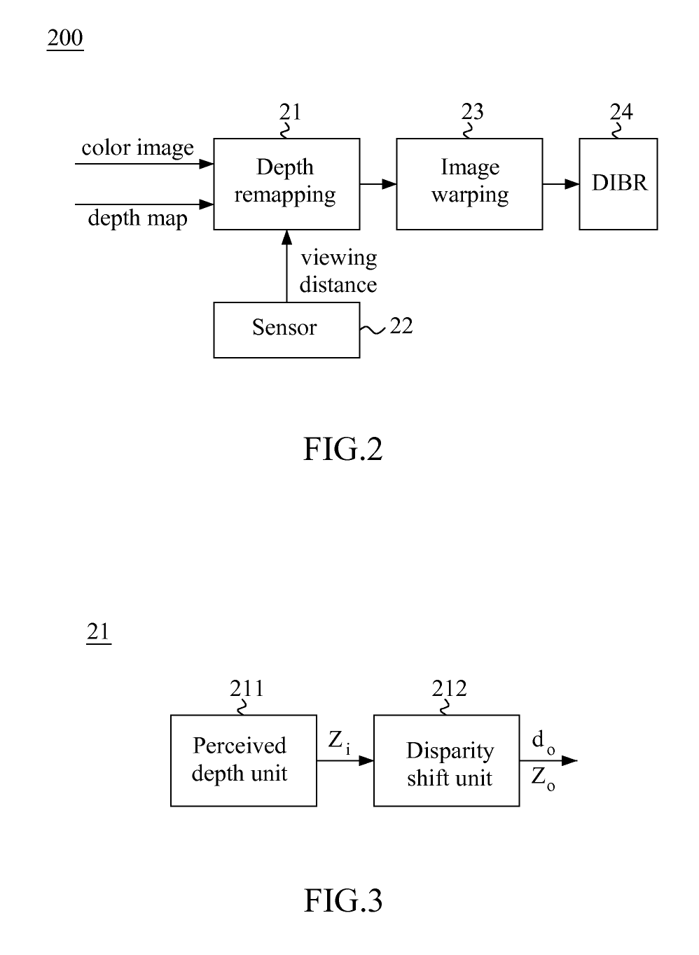

FIG. 2 shows a block diagram illustrative of a system 200 of viewer centric depth adjustment for stereoscopic images according to one embodiment of the present invention.

In the embodiment, the system 200 includes a depth remapping unit 21 configured to receive a color image and a depth map. The depth remapping unit 21 also receives viewing distance from a sensor 22, such as an ultrasonic sensor, that measures the viewing distance of a viewer from a screen. Based on the color image, the depth map and the viewer distance, the depth remapping unit 21 remaps (or shifts) depth values of the depth map such that the viewer perceives the same depth at different viewing distances.

FIG. 3 shows a detailed block diagram of the depth remapping unit 21 of FIG. 2. Specifically, the depth remapping unit 21 includes a perceived depth unit 211 that is configured to decide original perceived depth Zᵢ. In the embodiment, the original perceived depth Zᵢ is decided by:

$${Z}_{i} = \frac{e \times D}{e - {d}_{i}}$$

where D is the viewing distance, e is interocular distance which is, for example, set to 6.5 cm, and dᵢ is initial image disparity.

The depth remapping unit 21 also includes a disparity shift unit 212 that is configured to shift image disparity without changing viewer's perceived depth. In the embodiment, shifted image disparity dₒ is decided by:

$${d}_{o} = e - \frac{e \times ( D - Δ D )}{{Z}_{i} - Δ D}$$

where ΔD is viewing distance change.

According to the shifted image disparity dₒ, a new perceived depth Zₒ may be obtained. As a result, the embodiment may reduce the depth distortion and keep the same stereo perception under different viewing condition.

Referring to FIG. 2, the system 200 further includes an image warping unit 23 utilized to prevent size distortion while applying depth shifting, compared with a conventional system that seldom takes image warping into account and thus normally causes size distortion. To deal with this artifact, the embodiment proposes image resizing algorithm to reconstruct the original scale. Geometry assumption is used to get the scaling ratio. When a viewer moves close to the objects, the viewer feels the nearer the object, the bigger it grows in the real world viewing experience. Besides, for the scene far from the viewer, it almost remains the same size. Using the geometry relation we can solve the resizing ratio for each object. In the embodiment, the scaling ratio may be decided by equations as following:

$$ratio = \frac{{Z}_{i}}{D} \times \frac{D + Δ D}{{Z}_{o}}$$

$${x}_{o} = {x}_{i} \times ratio + \frac{width}{2}$$

where ratio is the scaling ratio, xᵢ is original horizontal position, xₒ is virtual position, and width is extent of a screen from side to side.

In other words, the image warping unit 23 first calculates the original horizontal position xᵢ and then calculates the virtual position xₒ according to the viewer's movement.

Finally, the color image and the depth map processed by the depth remapping unit 21 and the image warping unit 23 are then forwarded to a depth image-based rendering (DIBR) unit 24. The DIBR unit 24 may be implemented by conventional structures and algorithms, and implementing details are thus omitted here for brevity.

According to the stereoscopic image adjustment scheme discussed above, absolute disparity remapping for specific viewing distance is first adopted, and then image resizing is applied to deal with inconsistency of monocular cues and binocular cues, therefore improving 3D viewing experience. Compared with conventional image rendering, the embodiment discussed above may reduce distortion of image by adjusting according to viewing conditions.

Although specific embodiments have been illustrated and described, it will be appreciated by those skilled in the art that various modifications may be made without departing from the scope of the present invention, which is intended to be limited solely by the appended claims.

What is claimed is:

1. A system of viewer centric depth adjustment, comprising:
a sensor configured to measure viewing distance of a viewer from a screen; and
a depth remapping unit configured to receive a color image, a depth map and the viewing distance, and accordingly to remap depth values of the depth map such that the viewer perceives same depth at different viewing distances.

2. The system of claim 1, wherein the depth remapping unit comprises:
a perceived depth unit configured to decide original perceived depth; and
a disparity shift unit configured to shift image disparity without changing viewer's perceived depth, therefore obtaining a new perceived depth according to the shifted image disparity.

3. The system of claim 2, wherein the original perceived depth Zᵢ is decided by:
$${Z}_{i} = \frac{e \times D}{e - {d}_{i}}$$
where D is the viewing distance, e is interocular distance and dᵢ is initial image disparity.

4. The system of claim 3, wherein the shifted image disparity dₒ is decided by:
$${d}_{o} = e - \frac{e \times ( D - Δ D )}{{Z}_{i} - Δ D}$$
where ΔD is viewing distance change.

5. The system of claim 1, further comprising an image warping unit coupled to receive result of the depth remapping unit to prevent size distortion while applying depth remapping.

6. The system of claim 5, wherein the image warping unit adopts resizing algorithm to obtain a scaling ratio.

7. The system of claim 6, wherein the scaling ratio is obtained by geometry assumption that when the viewer moves close to an object, the viewer feels the nearer the object, the bigger it grows in real world viewing experience, and for the scene far from the viewer, it almost remains the same size.

8. The system of claim 6, wherein the scaling ratio is decided by equation as following:
$$ratio = \frac{{Z}_{i}}{D} \times \frac{D + Δ D}{{Z}_{o}}$$
where D is the viewing distance, ΔD is viewing distance change, Zᵢ is an original perceived depth, Zₒ a new perceived depth and ratio is the scaling ratio.

9. The system of claim 8, wherein the image warping unit calculates original horizontal position xᵢ and then calculates virtual position xₒ by equation as following:
$${x}_{o} = {x}_{i} \times ratio + \frac{width}{2}$$
where width is extent of the screen from side to side.

10. The system of claim 1, further comprising a depth image-based rendering (DIBR) unit configured to receive the color image and the remapped depth map.

11. A method of viewer centric depth adjustment, comprising:
sensing to measure viewing distance of a viewer from a screen; and
receiving a color image, a depth map and the viewing distance, and accordingly remapping depth values of the depth map such that the viewer perceives same depth at different viewing distances.

12. The method of claim 11, wherein the remapping step comprises:
deciding original perceived depth; and
shifting image disparity without changing viewer's perceived depth, therefore obtaining a new perceived depth according to the shifted image disparity.

13. The method of claim 12, wherein the original perceived depth Zᵢ is decided by:
$${Z}_{i} = \frac{e \times D}{e - {d}_{i}}$$
where D is the viewing distance, e is interocular distance and dᵢ is initial image disparity.

14. The method of claim 13, wherein the shifted image disparity dₒ is decided by:
$${d}_{o} = e - \frac{e \times ( D - Δ D )}{{Z}_{i} - Δ D}$$
where ΔD is viewing distance change.

15. The method of claim 11, further comprising an image warping step for receiving result of the remapping step to prevent size distortion while applying depth remapping.

16. The method of claim 15, wherein the image warping step adopts resizing algorithm to obtain a scaling ratio.

17. The method of claim 16, wherein the scaling ratio is obtained by geometry assumption that when the viewer moves close to an object, the viewer feels the nearer the object, the bigger it grows in real world viewing experience, and for the scene far from the viewer, it almost remains the same size.

18. The method of claim 16, wherein the scaling ratio is decided by equation as following:
$$ratio = \frac{{Z}_{i}}{D} \times \frac{D + Δ D}{{Z}_{o}}$$
where D is the viewing distance, ΔD is viewing distance change, Zᵢ is an original perceived depth, Zₒ a new perceived depth and ratio is the scaling ratio.

19. The method of claim 18, wherein the image warping step calculates original horizontal position xᵢ and then calculates virtual position xₒ by equation as following:
$${x}_{o} = {x}_{i} \times ratio + \frac{width}{2}$$
where width is extent of the screen from side to side.

20. The method of claim 11, further comprising a depth image-based rendering (DIBR) step for receiving the color image and the remapped depth map.
